(19) United States
(12) Patent Application Publication
(10) Pub. No.: US 2015/0294778 A1
(43) Pub. Date: Oct. 15, 2015

(54) COIL FIXATION STRUCTURE

(71) Applicant: YAZAKI CORPORATION, Tokyo (JP)

(72) Inventors: Shouichi FURUKAWA, Susono-shi (JP); Koji MIYAWAKI, Susono-shi (JP)

(21) Appl. No.: 14/683,191

(22) Filed: Apr. 10, 2015

(30) Foreign Application Priority Data
Apr. 14, 2014 (JP) 2014-082702

(51) Int. Cl. H01F 27/06

(52) U.S. Cl. CPC H01F 27/06

(57) ABSTRACT

A coil fixation structure includes: a coil including an annular core and a conductor wire wound around the annular core; an arrangement member including an arrangement part on which the coil is arranged with an outer diameter side surface of the coil in contact with the arrangement part; a shaft member arranged through a center part of the coil; and a case housing the arrangement member and including a locking portion engaging with the shaft member and fixing the coil to the arrangement part.

### CROSS REFERENCE TO RELATED APPLICATION

This application is based upon and claims the benefit of priority from the prior Japanese Patent Application No. 2014-082702, filed on Apr. 14, 2014, the entire contents of which are incorporated herein by reference.

### BACKGROUND

1. Technical Field

The present invention relates to a coil fixation structure, and, more particularly, relates to a coil fixation structure in which coils are arranged on arrangement parts of an arrangement member with outer diameter side surfaces in contact with the arrangement parts.

2. Related Art

JP 2001-110655 A discloses a coil fixation structure which includes coils formed by winding conductor wires around annular cores, a main body which includes arrangement parts on which these coils are arranged with outer diameter side surfaces in contact with the arrangement parts, and a printed circuit board which is an arrangement member on which this main body is arranged.

In the coil fixation structure, the main body includes a flat support part which is orthogonal to the printed circuit board. This support part is provided with a base part which includes a pair of inclined surfaces with which the outer diameter side surfaces of the coils are arranged in contact. The support part is provided with a through-hole concentrically around center parts of the coils in a state where the coils are arranged on the base part.

In the coil fixation structure, the coils are arranged on the base part such that the outer diameter side surfaces of the coils are placed in contact with a pair of inclined surfaces, and a banding band is arranged such that the banding band is inserted through the through-hole and the center parts of the coils, and this banding band fixes the coil to the main body.

By arranging the main body to which these coils are fixed, orthogonally to the printed circuit board, the coils are arranged upright on the printed circuit board. By arranging the coils in this way, it is possible to reduce space for arranging the coils on the printed circuit board compared to a state where the coils are arranged such that a coil side surfaces are parallel to a printed circuit board, i.e., the coils are laid and arranged on the printed circuit board.

### SUMMARY

By the way, by fixing the coils such that the coils cannot rotate as in the above coil fixation structure, it is possible to reduce a stress to be applied to lead parts which connect the coils and the arrangement member when an external force is applied to the coils due to vibration or the like, and keep connection reliability of the coils.

However, in the coil fixation structure, the main body which includes the arrangement parts includes the base part, the through-hole and the like and the structure of the main part becomes complex, and a banding band is used to fix the coils to the main body and therefore the number of parts increases compared to a structure in which coils are laid and arranged.

An object of the present invention is to provide a coil fixation structure which can fix coils while reducing the number of parts in a simple structure, and keep connection reliability of the coils.

A coil fixation structure in accordance with some embodiments includes: a coil including an annular core and a conductor wire wound around the annular core; an arrangement member including an arrangement part on which the coil is arranged with an outer diameter side surface of the coil in contact with the arrangement part; a shaft member arranged through a center part of the coil; and a case housing the arrangement member and including a locking portion engaging with the shaft member and fixing the coil to the arrangement part.

According to the above configuration, the shaft member is inserted through the center parts of the coils, so that it is possible to make the shaft member support the coils. Consequently, it is not necessary to use another member such as a banding band or an adhesive to support the coils.

Further, the case is provided with locking portions which engage with the shaft member and fix the coils to the arrangement parts. Consequently, it is possible to position the coils on the arrangement parts by engaging the shaft member which supports the coils, with the locking portion of the case.

Hence, even when an external force is applied to the coils due to vibration or the like, the coils do not move from the arrangement parts. Consequently, it is possible to prevent the conductor wires of the coils or lead wires connected to the conductor wires from being broken, and keep connection reliability of the coils.

In addition, by providing the locking portions which engage with the shaft member to the case, when an external force is applied to the coils, it is possible to allow this external force to transmit to the case from the shaft member and escape, and keep more connection reliability of the coils.

Consequently, the coil fixation structure according to the embodiments can fix the coils while reducing the number of parts in a simple structure, and keep connection reliability of the coils.

The shaft member may be arranged through the center part of the coil in a press fit condition.

According to the above configuration, it is possible to disable rotation of the coils with respect to the shaft member by setting the outer diameter of the shaft member and the inner diameters of the center parts of the coils, and it is not necessary to provide an engaging portion to an outer circumference of the shaft member and inner circumferences of the center parts of the coils.

The coil fixation structure may further include a plurality of the coils. The coils may be arranged in parallel on the arrangement part concentrically around the center parts of the coils. The shaft member may be arranged through the center parts of the coils.

According to the above configuration, it is possible to fix a plurality of coils using one shaft member, reduce the number of parts and improve assembly.

The shaft member may include a partition wall partitioning neighboring coils of the coils.

According to the above configuration, by adjusting the width of the partition wall, it is possible to adjust an interval between the neighboring coils, and adjust positions of the arrangement part at which the coils are arranged.

The shaft member may include an engaging portion engaging with the locking portion in a rotation direction of the shaft member.

According to the above configuration, the shaft member does not rotate with respect to the locking portions, so that it is possible to more stably fix the coils to the arrangement parts.

An external shape of the shaft member may include a first outer diameter region having a first outer diameter and a second outer diameter region having a second outer diameter different from the first outer diameter.

According to the above configuration, the external shape of the shaft member is not a true circle, and a portion of the first outer diameter region whose distance from the center to the outer diameter part is different from that of a portion of the second outer diameter region engages with the inner circumferences of the center parts of the coils. Consequently, it is possible to disable rotation of the coils with respect to the shaft member.

According to the above configuration, it is possible to provide a coil fixation structure which can fix the coils while reducing the number of parts in a simple structure, and keep connection reliability of the coils.

### BRIEF DESCRIPTION OF DRAWINGS

FIG. 1 is an exploded perspective view of a coil fixation structure according to a first embodiment of the present invention.

FIG. 2 is a cross-sectional view of the coil fixation structure according to the first embodiment of the present invention.

FIG. 3 is a front view showing that a shaft member is pressed fit in and inserted through coils of the coil fixation structure according to the first embodiment of the present invention.

FIG. 4 is a front view showing that the shaft member is pressed fit in and inserted through the coils of the coil fixation structure according to the first embodiment of the present invention.

FIG. 5 is a perspective view showing that the coils of the coil fixation structure according to the first embodiment of the present invention are arranged on an arrangement member.

FIG. 6 is a front view showing that the arrangement member of the coil fixation structure according to the first embodiment of the present invention is housed in a case main body.

FIG. 7 is a front view showing that the arrangement member of the coil fixation structure according to the first embodiment of the present invention is housed in the case main body.

FIG. 8 is a perspective view showing that a cover is assembled to the case main body of the coil fixation structure according to the first embodiment of the present invention.

FIG. 9A is a perspective view of a shaft member of a coil fixation structure according to a second embodiment of the present invention.

FIG. 9B is a front view of the shaft member of the coil fixation structure according to the second embodiment of the present invention.

FIG. 10A is a side view showing that an engaging portion which includes one protrusion is provided to a shaft member of a coil fixation structure according to the third embodiment of the present invention.

FIG. 10B is a side view showing that an engaging portion which includes one groove part is provided to the shaft member of the coil fixation structure according to the third embodiment of the present invention.

FIG. 10C is a side view showing that an engaging portion which includes pluralities of protrusions and groove parts is provided to the shaft member of the coil fixation structure according to the third embodiment of the present invention.

FIG. 11A is a side view showing that an external shape of the shaft member of the coil fixation structure according to the third embodiment of the present invention is triangular;

FIG. 11B is a side view showing that an external shape of the shaft member of the coil fixation structure according to the third embodiment of the present invention is quadrangular.

FIG. 11C is a side view showing that that an external shape of the shaft member of the coil fixation structure according to the third embodiment of the present invention is pentagonal.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

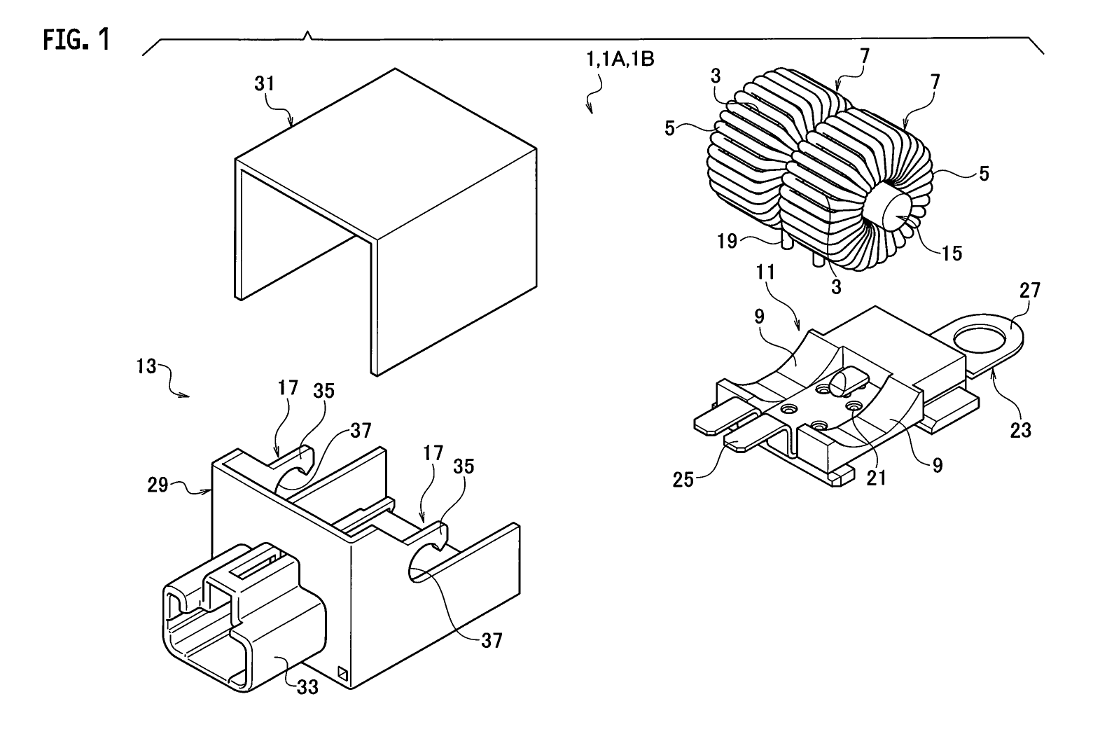

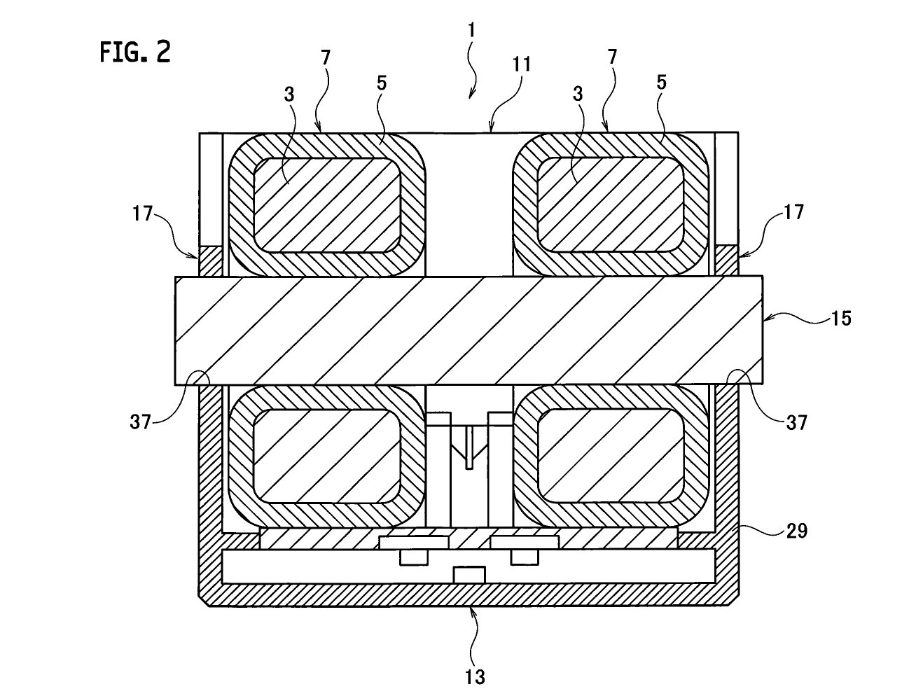

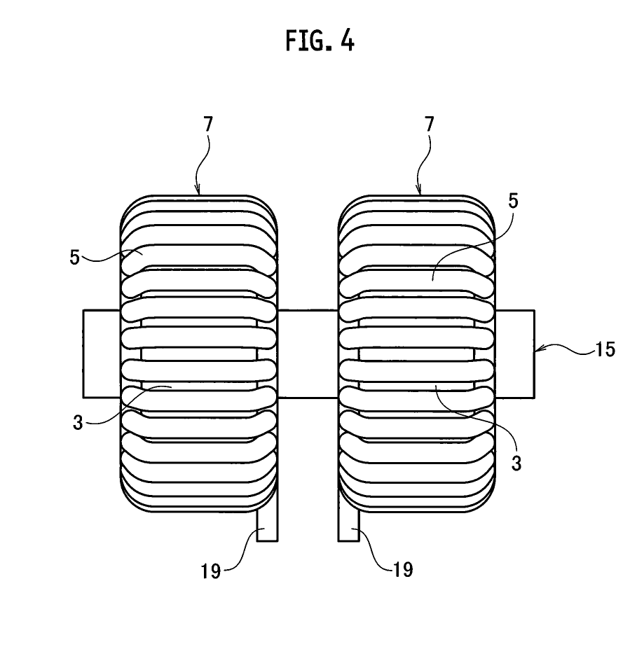

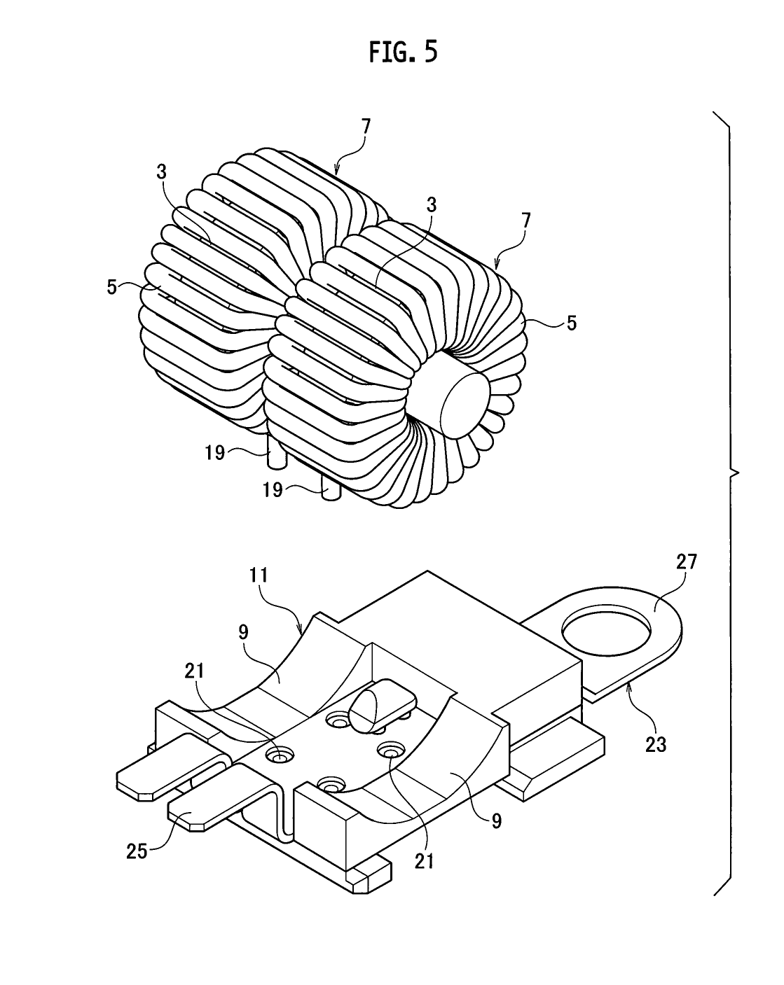

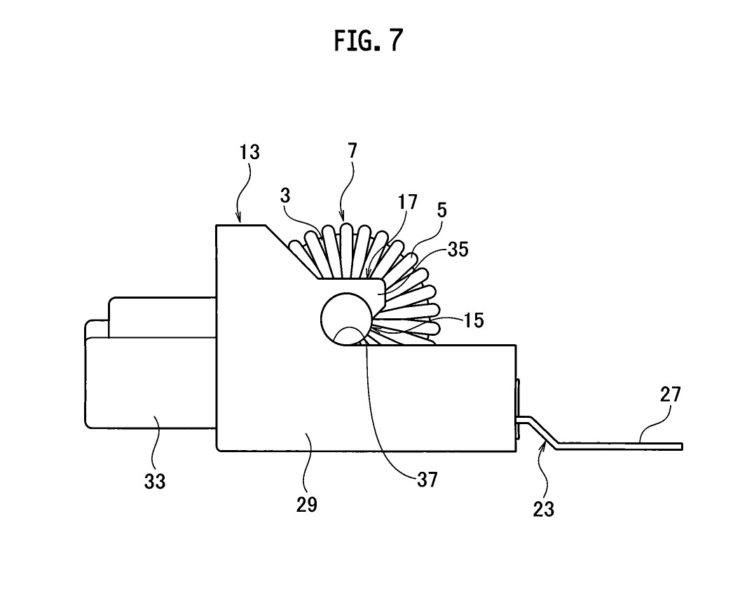

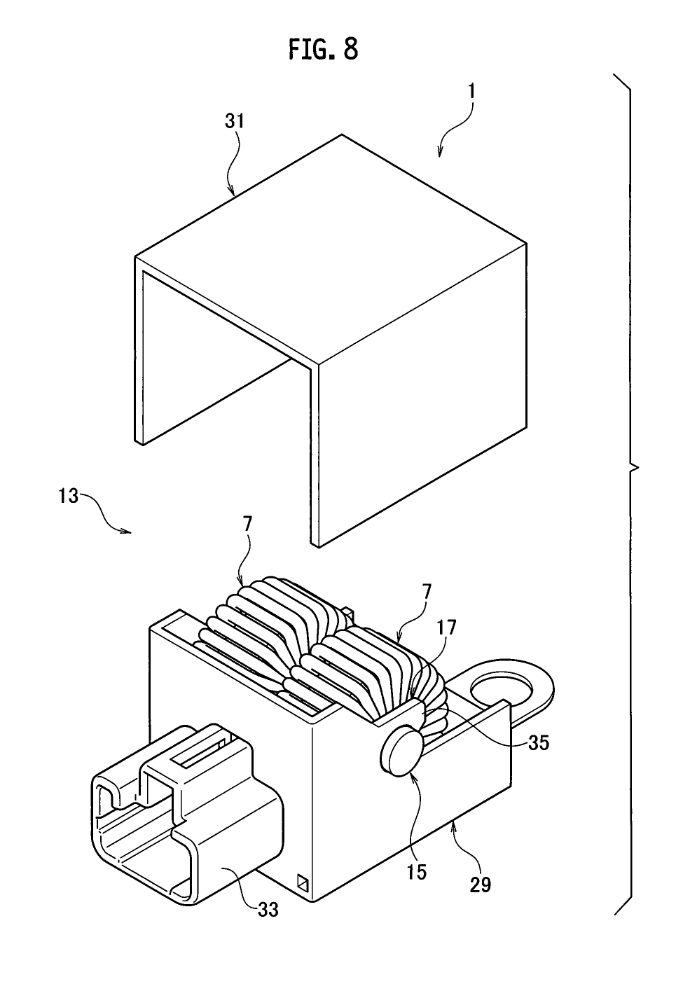

A coil fixation structure according to embodiments of the present invention will be described with reference to FIGS. 1 to 11C.

### First Embodiment

A first embodiment will be described with reference to FIGS. 1 to 8.

A coil fixation structure 1 according to the first embodiment includes coils 7 which are formed by winding conductor wires 5 around annular cores 3, an arrangement member 11 which includes arrangement parts 9 on which the coils 7 are arranged with outer diameter side surfaces in contact with the arrangement parts 9, and a case 13 which houses the arrangement member 11.

A shaft member 15 is inserted through center parts of the coils 7. The case 13 is provided with locking portions 17 which engage with the shaft member 15 and fix the coils 7 to the arrangement parts 9.

The shaft member 15 is pressed fit in and inserted through the center parts of the coils 7.

The coils 7 are arranged in parallel on arrangement parts 9 concentrically around the center parts. The shaft member 15 is inserted through the center parts of the coils 7.

As shown in FIGS. 1 to 8, the coil 7 is formed by winding the conductor wire 5 which is made of a conductive material, predetermined times around an outer circumference of the core 3 which is made of a magnetic material and is formed in an annular shape.

The plurality of (two in this case) coils 7 is arranged in parallel concentrically around the center parts in a state where the coils 7 are upright such that the outer diameter side surfaces are in contact with the arrangement parts 9 of the arrangement member 11.

Both end parts of the conductor wires 5 of the coils 7 are electrically connected to a conductor part 23 by way of soldering or the like through a plurality of (four in this case) through-holes 21 provided to the arrangement member 11 through lead wires 19.

The arrangement member 11 includes the conductor part 23 which is made of a conductive material such as a bus bar and is insert-molded using an insulation material such as synthetic resin, and includes the arrangement parts 9.

A pair of terminal parts 25 and 27 of the conductor part 23 is exposed from both sides of the insulation material. The one terminal part 25 is a connection part connected to the other party terminal housed in a connector connected to a wire. The other terminal part 27 is a connection part directly connected to a device or a power supply.

The plurality of (two in this case) arrangement parts 9 is made of an insulation material, and is formed in curved shapes on one surface side of the arrangement member 11 to meet outer diameter side surfaces of the coils 7. The outer diameter side surfaces of the coils 7 are arranged in contact with the arrangement parts 9. The shaft member 15 is pressed fit in and inserted through the center parts of the coils 7 arranged on the arrangement parts 9.

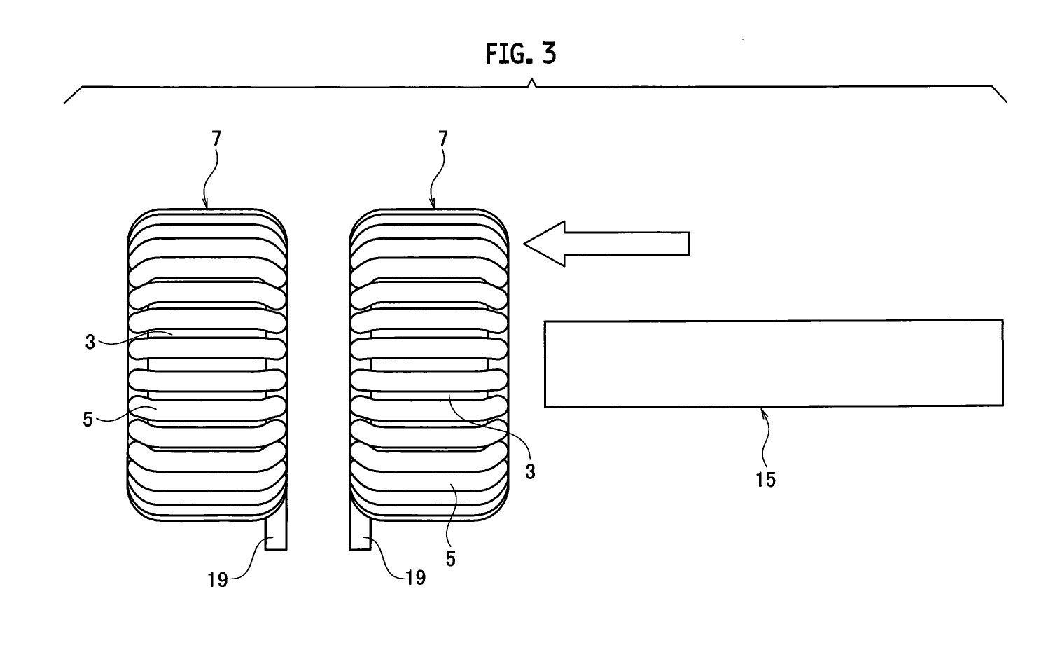

The shaft member 15 is made of an insulation material, and is formed in a columnar shape. Before the coils 7 are arranged on the arrangement parts 9, the shaft member 15 is pressed fit in the center parts of the coils 7 such that the shaft member 15 is inserted through the center parts of the coils 7 arranged in parallel concentrically around the center parts as indicated by an arrow in FIG. 3.

The shaft member 15 is pressed fit in and inserted through the center parts of the coils 7 in this way to be in a press fit condition, so that the coils 7 do not rotate around the shaft member 15. In addition, it is possible to fix the coils 7 using one shaft member 15 and arrange the coils 7 on the arrangement parts 9 of the arrangement member 11 and, consequently improve assembly. The arrangement member 11 including the arrangement parts 9 on which the coils 7 with the shaft member 15 pressed fit therein are arranged is housed in the case 13.

The case 13 is made of an insulation material such as synthetic resin, and includes a case main body 29 and a cover 31. The case main body 29 is formed in a housing shape whose top surface side and one lateral surface side are open. A cross section of the cover 31 is formed in a U shape. The arrangement member 11 is housed in the case main body 29 from the one lateral surface side, and then the cover 31 is assembled from the top surface side.

On the arrangement member 11 housed in the case 13, one terminal part 25 is arranged in a connector part 33 provided on the other lateral surface side of the case 13, and the other terminal part 27 is exposed to the outside from one lateral surface side of the case 13. The locking portions 17 are provided on both of the lateral surface sides of the case main body 29 of the case 13.

The locking portion 17 includes a locking arm 35 which is provided to be capable of deflecting in a height direction of the case 13, and an engaged part 37 of a circular hole part whose inner diameter is set equal to the outer diameter of the shaft member 15 by the locking arm 35 and a sidewall of the case main body 29.

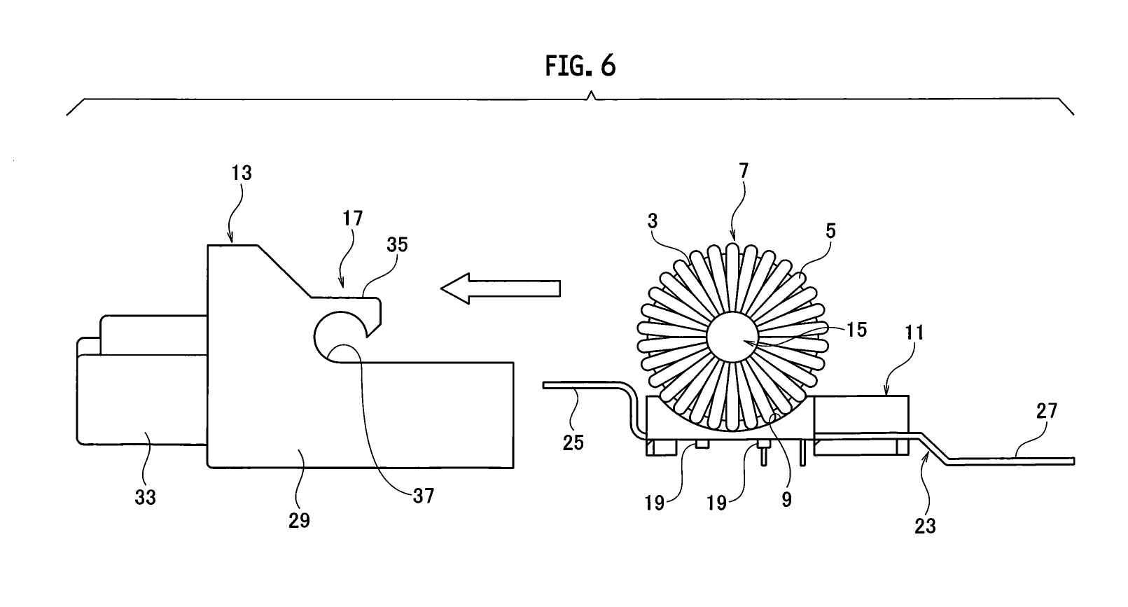

As indicated by an arrow in FIG. 6, when the arrangement member 11 with the coils 7 arranged on the arrangement parts 9 is housed in the case main body 29, the outer circumference surface of the shaft member 15 contacts free end sides of the locking arms 35 and the locking portions 17 deflect the locking arms 35 upward.

Further, when the arrangement member 11 is fully housed in the case main body 29, the locking arms 35 are restored toward a lower side of the case 13, the outer circumference surface of the shaft member 15 engages with the inner circumference surfaces of the engaged parts 37, and the locking portions 17 lock the shaft member 15.

The shaft member 15 to which the coils 7 are fixed in such a way that the coils 7 cannot rotate are locked by the locking portions 17 of the case 13, so that the coils 7 are positioned on the arrangement parts 9 and fixed. Consequently, even when an external force such as vibration is applied to the coils 7, the coils 7 do not move from the arrangement parts 9.

In addition, even when an external force is applied to the coils 7, it is possible to allow this external force to transmit to the case 13 from the shaft member 15 and escape, and reduce a burden on the lead wires 19 connected to the coils 7.

Hence, it is possible to substantially reduce a burden applied to the lead wires 19 connected to the both end parts of the conductor wires 5 of the coils 7 in a simple structure without using another member such as a banding band and an adhesive to support the coils 7, and improve connection reliability of the coils 7 and the arrangement member 11.

The coil fixation structure 1 is assembled by pressing the coils 7 fit in the shaft member 15 such that the shaft member 15 is inserted through the respective center parts of the coils 7 arranged in parallel. Next, the coils 7 fixed by pressing the shaft member 15 are arranged on the arrangement parts 9 of the arrangement member 11.

Further, the arrangement member 11 is housed in the case main body 29, the shaft member 15 deflects the locking arms 35 of the locking portions 17, restoring forces of the locking arms 35 engage the inner circumference surfaces of the engaged parts 37 with the outer circumference surface of the shaft member 15, the case main body 29 is assembled to the cover 31 and assembly is finished.

In the coil fixation structure 1, the shaft member 15 is inserted through the center parts of the coils 7. Consequently, it is possible to make the shaft member 15 support the coils 7, and it is not necessary to use another member such as a banding band or an adhesive to support the coils 7.

The case 13 is provided with the locking portions 17 which engage with the shaft member 15 and fix the coils 7 to the arrangement parts 9. Consequently, by engaging the shaft member 15 which supports the coils 7, with the locking portions 17 of the case 13, it is possible to position the coils 7 on the arrangement parts 9.

Hence, even when an external force is applied to the coils 7 due to vibration or the like, the coils 7 do not move from the arrangement parts 9. Consequently, it is possible to prevent the conductor wires 5 of the coils 7 and the lead wires 19 connected to the conductor wires 5 from being broken, and keep connection reliability of the coils 7.

In addition, by providing the locking portions 17 which engage with the shaft member 15 to the case 13, when an external force is applied to the coils 7, it is possible to allow this external force to transmit to the case 13 from the shaft member 15 and escape, and keep more connection reliability of the coils 7.

Consequently, the coil fixation structure 1 can fix the coils 7 while reducing the number of parts in a simple structure, and keep connection reliability of the coils 7.

Further, the shaft member 15 is pressed fit in and inserted through the center parts of the coils 7. Consequently, it is possible to disable rotation of the coils 7 with respect to the shaft member 15 by setting the outer diameter of the shaft member 15 and the inner diameter of the center parts of the coils 7, and it is not necessary to provide an engaging portion to the outer circumference of the shaft member 15 and the inner circumferences of the center parts of the coils 7.

Further, the shaft member 15 is inserted through the center parts of the coils 7, so that it is possible to fix the coils 7 using one shaft member 15, reduce the number of parts and improve assembly.

### Second Embodiment

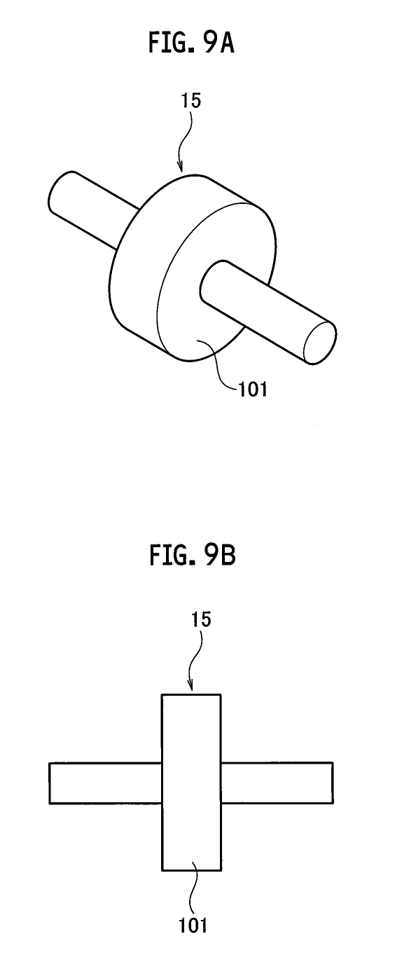

A second embodiment will be described with reference to FIGS. 9A and 9B.

In a coil fixation structure 1A according to the second embodiment, a shaft member 15 is provided with a partition wall 101 which partitions between neighboring coils 7 and 7 (see FIG.

As shown in FIGS. 9A and 9B, a center part of the shaft member 15 is provided with the partition wall 101 which is formed in a disk shape. The partition wall 101 is made of an insulation material formed integrally with the shaft member 15. The partition wall 101 is positioned between the neighboring coils 7 and 7 when the coils 7 and 7 are pressed fit in the shaft member 15, and the width (axial direction length) of the partition wall 101 is set such that the coils 7 and 7 are positioned on arrangement parts 9 (see FIG. 1) of an arrangement member 11.

In the coil fixation structure 1A, the shaft member 15 is provided with the partition wall 101 which partitions between the neighboring coils 7 and 7. Consequently, by adjusting the width of the partition wall 101, it is possible to adjust an interval between the neighboring coils 7 and 7, and adjust arrangement positions of the coils 7 and 7 with respect to the arrangement parts 9. In addition, it is possible to keep the insulation property between the neighboring coils 7 and 7.

### Third Embodiment

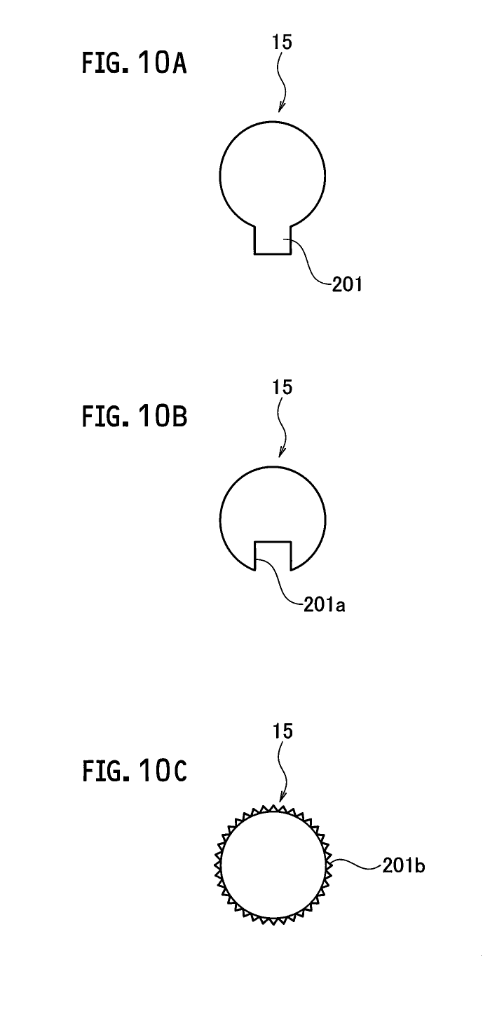

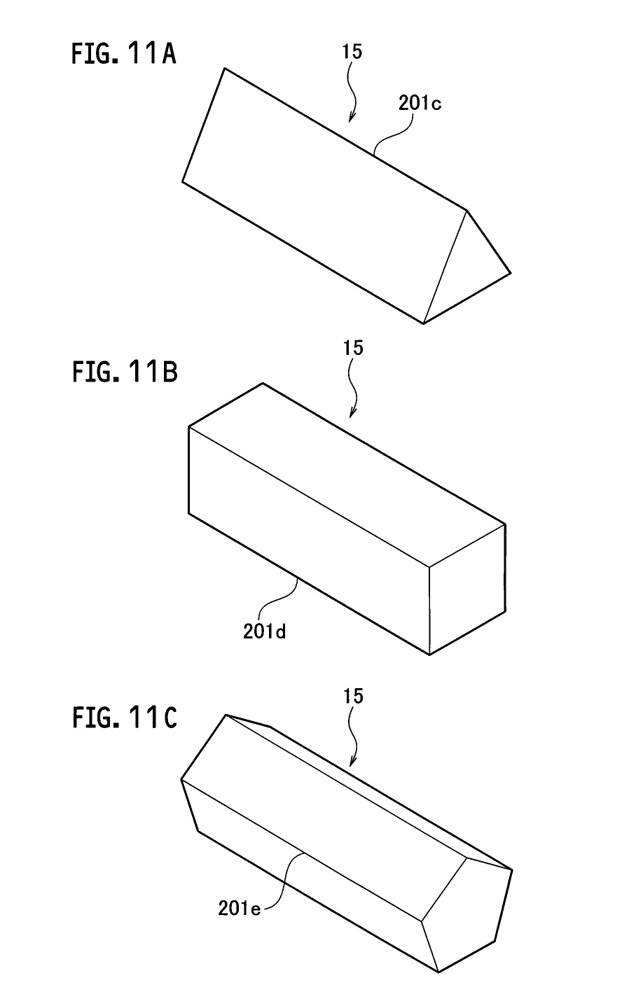

A third embodiment will be described with reference to FIGS. 10A to 10C and 11A to 11C.

In a coil fixation structure 1B according to the third embodiment, a shaft member 15 is provided with engaging portions 201, and 201a to 201e which engage with locking portions 17 (see FIG. 1) in a rotation direction of the shaft member 15. Further, an external shape of the shaft member 15 includes a portion whose distance from a center to an outer diameter part is different from that of a portion of the other outer diameter region. That is, the external shape of the shaft member 15 includes a first outer diameter region including a first outer diameter, and a second outer diameter region including a second outer diameter different from the first outer diameter.

As shown in FIG. 10A, the engaging portion 201 which includes one protrusion provided to protrude along a length direction of the shaft member 15 is provided to an outer circumference of the shaft member 15. In addition, although not shown, concave parts which can engage with the engaging portion 201 are formed at engaged parts 37 (see FIG. 1) of the locking portions 17 which the shaft member 15 engages with.

By engaging the shaft member 15 with the locking portions 17, the engaging portion 201 engages with the concave parts formed at the engaged parts 37. The engagement of this engaging portion 201 prevents the shaft member 15 from rotating in the engaged parts 37 of the locking portions 17, and the locking portions 17 can more stably lock the shaft member 15.

In addition, a shape of the engaging portion 201 may be a shape of the engaging portion 201a which includes one groove part formed along the length direction of the shaft member 15 as shown in FIG. 10B, or a shape of the engaging portion 201b which includes pluralities of protrusions or groove parts formed along the length direction of the shaft member 15 as shown in FIG. 10C. Further, an external shape of the shaft member 15 as shown in FIGS. 11A to 11C may have a polygonal shape such as a triangular shape, a quadrangular shape or a pentagonal shape. Corner parts of the respective shapes may be the engaging portions 201c, 201d and 201e, and the shapes of the engaged parts 37 of the locking portions 17 only need to be set according to the shape of the engaging portion 201.

That is, the external shape of the shaft member 15 shown in FIGS. 10A to 10C and 11A to 11C includes a portion whose distance from the center to the outer diameter part is different from that of the portion of the other outer diameter region. That is, the external shape of the shaft member 15 is set to a shape other than a true circle.

More specifically, distances of the engaging portions 201, 201a and 201b (portions of the first outer diameter regions) of the shaft member 15 shown in FIGS. 10A to 10C from the center to the outer diameter part are different from that of the portion of the other outer diameter region (the portion of the second outer diameter region). Distances of the engaging portions 201c, 201d and 201e (the portions of the first outer diameter region) which are corner parts of the triangular shape, the quadrangular shape and the pentagonal shape of the shaft member 15 shown in FIGS. 11A to 11C from the center to the outer diameter part are different from that of the portion of the other outer diameter region (the portion of the second outer diameter region).

By setting the external shape of the shaft member 15 in this way, the portion whose distance from the center to the outer diameter part is different from that of the portion of the other outer diameter region engages with the inner circumferences of the center parts of coils 7 and the inner circumferences of the engaged parts 37 of the locking portions 17 in the rotation direction. Consequently, it is possible to fix the coils 7 such that the coils 7 cannot rotate with respect to the shaft member 15, and fix the shaft member 15 to the locking portions 17.

In addition, by shaping the shapes of the center parts of the center parts of the coils 7 through which the shaft member 15 is inserted, to meet the external shape of the shaft member 15, it is possible to reinforce a force of fixing the coils 7 to the shaft member 15. Further, the shapes of the engaged parts 37 of the locking portions 17 are shaped to meet the external shape of the shaft member 15. However, when, for example, the external shape of the shaft member 15 includes multiple engaging portions like corner parts of a polygonal shape as shown in FIGS. 11A to 11C, shapes of the engaged parts 37 of the locking portions 17 may be formed in circular shapes.

In coil fixation structures 1A and 1B, the shaft member 15 is provided with the engaging portions 201, and 201a to 201e which engage with the locking portions 17 in the rotation direction of the shaft member 15. Consequently, the shaft member 15 does not rotate with respect to the locking portions 17, and it is possible to more stably fix the coils 7 with respect to arrangement parts 9 (see FIG. 1).

Further, the external shape of the shaft member 15 includes a portion whose distance from the center to the outer diameter part is different from that of the portion of the other outer diameter region. Consequently, the external shape of the shaft member 15 does not become a true circle, and the portion whose distance from that of the center to the outer diameter part is different from the portion of the other outer diameter region engages with the inner circumferences of the center parts of the coils 7, so that it is possible to disable rotation of the coils 7 with respect to the shaft member 15.

In addition, in coil fixation structures 1, 1A and 1B according to the embodiments of the present invention, the coils 7 is fixed to one shaft member 15. The coil fixation structure is not limited to this, and one shaft member may be fixed to one coil.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A coil fixation structure comprising:
a coil comprising an annular core and a conductor wire wound around the annular core;
an arrangement member comprising an arrangement part on which the coil is arranged with an outer diameter side surface of the coil in contact with the arrangement part;
a shaft member arranged through a center part of the coil; and
a case housing the arrangement member and comprising a locking portion engaging with the shaft member and fixing the coil to the arrangement part.

2. The coil fixation structure according to claim 1, wherein the shaft member is arranged through the center part of the coil in a press fit condition.

3. The coil fixation structure according to claim 1, further comprising a plurality of the coils, wherein
the coils are arranged in parallel on the arrangement part concentrically around the center parts of the coils, and
the shaft member is arranged through the center parts of the coils.

4. The coil fixation structure according to claim 3, wherein the shaft member comprises a partition wall partitioning neighboring coils of the coils.

5. The coil fixation structure according to claim 1, wherein the shaft member comprises an engaging portion engaging with the locking portion in a rotation direction of the shaft member.

6. The coil fixation structure according to claim 1, wherein an external shape of the shaft member comprises:
a first outer diameter region having a first outer diameter; and
a second outer diameter region having a second outer diameter different from the first outer diameter.
